(19) United States
(12) Patent Application Publication
(10) Pub. No.: US 2015/0370125 A1
(43) Pub. Date: Dec. 24, 2015

(54) LIQUID CRYSTAL LENS

(71) Applicant: TDK CORPORATION, Tokyo (JP)

(72) Inventor: Shogo YONEMURA, Tokyo (JP)

(21) Appl. No.: 14/731,040

(22) Filed: Jun. 4, 2015

(30) Foreign Application Priority Data
Jun. 18, 2014 (JP) 2014-125361

(51) Int. Cl. G02F 1/1335

(52) U.S. Cl. CPC G02F 1/133526

(57) ABSTRACT

A liquid crystal lens of this invention is provided with (i) a first substrate having (a) a first electrode that has a hole and (b) a second electrode that is within the hole of the first electrode, and spaced from the first electrode; (ii) a second substrate having a third electrode; and (iii) a liquid crystal layer that is formed between an electrode formation surface of the first substrate and an electrode formation surface of the second substrate. In this liquid crystal lens, a functional film is arranged between the second substrate and the liquid crystal layer. At least part of the functional film has a region that has a continuous composition gradient in a film thickness direction.

### BACKGROUND OF THE INVENTION

(1) Field of the Invention

This invention relates to a liquid crystal lens that is driven by a voltage.

(2) Description of Related Art

When a voltage is applied to nematic liquid crystal, if a magnitude of the voltage is changed, an index of refraction of the nematic liquid crystal changes according to changes in the voltage. Because of this, a focal position of a lens in which nematic liquid crystal is applied can be adjusted without depending on a mechanical drive portion. This lens is a liquid crystal lens. A voltage that is applied to the nematic liquid crystal is called a drive voltage. A technology of a liquid crystal lens is disclosed in U.S. Pat. No. 6,859,333 and U.S. Pat. No. 7,218,375.

In JP2011-180373A, Sato et al. disclosed a technology that changes a focal position of a liquid crystal lens with a drive voltage lower than a conventional technology. The liquid crystal lens of Sato et al. was constituted by a glass substrate, a first electrode, an orientation film, a liquid crystal layer, a high resistance layer, a transparent insulation film, and second and third electrodes having opening portions. Sato et al. reported that a drive voltage is able to be lowered if a junction effect of a potential distribution of the high resistance layer is used.

For the high resistance layer used for the liquid crystal lens of Sato et al., transmittance becomes low in a visible light region (a wavelength of 360 [nm]-830 [nm]). Transmittance of the high resistance layer can be increased by making the high resistance layer thin. However, if a film thickness of the high resistance layer is made to be too thin, irregularity is generated in the conductivity of the high resistance layer. Irregularity in the conductivity of the high resistance layer destabilizes an operation of the liquid crystal lens.

In WO 2013/080819 A1, Okuzawa et al. disclosed a means of solving the above problem. The liquid crystal lens of Okuzawa et al. used a high resistance layer in which Al₂O₃ and MgO were added to a ZnO base material. Okuzawa et al. reported that even if the film thickness was not made to be thin, conductivity and transmittance could be set at a desired range as long as their high resistance layer was used.

### BRIEF SUMMARY OF THE INVENTION

We discovered that a conventional liquid crystal lens that is typified in JP2011-180373 and WO 2013/080819 A1 has the following problems.
(1) In a conventional liquid crystal lens, film stress of an insulation film is significantly different from that of a high resistance layer. Because of this, in a structure in which both film stress of an insulation film and film stress of a high resistance layer exist, there is a possibility that peeling may occur at an interface of the insulation film and the high resistance layer.
(2) In a conventional liquid crystal lens, optical characteristics (index of refraction and the like) of an insulation film may be different from those of a high resistance layer. In that case, reflection of or diffusion of incident light is generated at an interface of the insulation film and the high resistance layer. Due to this reflection or diffusion, optical characteristics of the liquid crystal lens deteriorate.
(3) In order to provide liquid crystal with a lens effect, an ideal potential distribution in a quadratic curve shape is needed (see FIG. 4a, which is mentioned later). If an error is made in the combination of an insulation layer and a high resistance layer, an ideal potential distribution cannot be obtained for the liquid crystal.

The liquid crystal lens of this invention does not have the above problems. The liquid crystal lens of this invention is provided with (i) a first substrate having a first electrode and/or a second electrode, and (ii) a second substrate having a third electrode. A liquid crystal layer is formed between an electrode formation surface of the first substrate and an electrode formation surface of the second substrate. The liquid crystal lens of this invention has the following characteristics.
(1) A functional film is arranged between (i) the first substrate and the electrode(s) and (ii) the liquid crystal layer.
(2) A composition of at least part of the functional film has a continuous gradient in a film thickness direction.

A “functional film” of this invention is provided with a single-layer structure. By using a single layer, a function of this functional film can be realized which could only be accomplished by a double-layer structure (which refers to a layered structure of an insulation layer and a high resistance layer) in a conventional liquid crystal lens. At least part of the functional film has a structure that has a continuous composition gradient in a film thickness direction. This “composition gradient” means that a concentration of a structural element of the functional film changes in a film thickness direction. Thus, this does not mean that the composition gradient of the functional layer of this invention replaces a structural element with another element. Because the functional film has this composition gradient, the functional film shows a slope of conductivity in the film thickness direction. Additionally, an index of refraction of the functional film of this invention does not rapidly change in the film thickness direction, but moderately changes in the film thickness direction. This is because the composition gradient of the functional film only changes the concentration without replacing a structural element. Simultaneously, internal stress of this functional film moderately changes in the film thickness direction. Because of this, there is no rapid change of stress inside of the functional film. Because the functional film of this invention has the above characteristics, the liquid crystal lens of this invention has the following characteristics.
(1) There is no film peeling that uses the inside of the functional film as a starting point.
(2) In a visible light region, transmittance does not deteriorate.
(3) An ideal potential distribution in a quadratic curve shape needed for a liquid crystal lens can be formed.

Additionally, for one of the means that forms a potential distribution in a quadratic curve shape, a hole can be formed in the second electrode, and then the third electrode can be arranged at a position apart from the second electrode without contacting the second electrode, in the hole of the second electrode. However, the liquid crystal lens of this invention is not necessarily limited to a model in which the second electrode has a hole. Even if the second electrode is formed as a structure with a hole, a slope is not generated in the conductivity of the functional film.

### BRIEF DESCRIPTION OF THE DRAWINGS

FIG. 1 is a cross-sectional view of a liquid crystal lens of Detailed Description 1.

FIG. 2 is a cross-sectional view of a liquid crystal lens of Detailed Description 2.

FIG. 3 is a perspective view of a liquid crystal lens of Detailed Description 1.

FIG. 4a is a schematic view showing an ideal potential distribution shape of a liquid crystal lens.

FIG. 4b is a schematic view showing an undesirable potential distribution shape of a liquid crystal lens.

FIG. 5 is a diagram showing a composition gradient of a liquid crystal lens in a film thickness direction of Detailed Description 1.

FIG. 6 is a diagram showing a potential distribution of a liquid crystal lens of Example 1.

FIG. 7 is a diagram showing transmittance data of a functional film 4 of Example 1.

FIG. 8 is an evaluation image of an interference fringe when the liquid crystal lens of Detailed Description 1 shows an insulation failure.

FIG. 9 is an evaluation image of an interference fringe of a liquid crystal lens of a good product of this Example.

FIG. 10 is a diagram showing a potential distribution of a liquid crystal lens of Example 11.

### DETAILED DESCRIPTION OF THE INVENTION

Hereafter, preferable examples of this invention are explained with reference to the drawings. Furthermore, this invention is not limited to the following examples. Additionally, structural elements explained below include ones that would have been easily attained by one of ordinary skill in the art and ones that are substantially the same. In addition, the structural elements explained below can be combined appropriately.

### Detailed Description 1

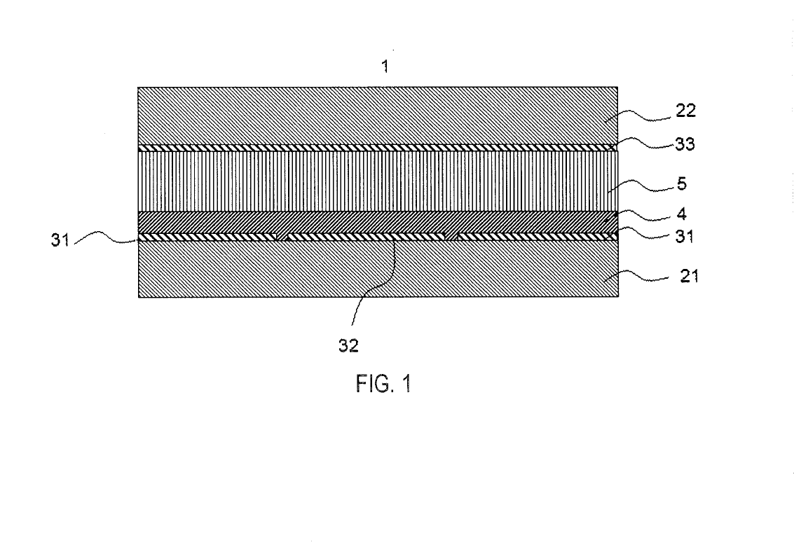

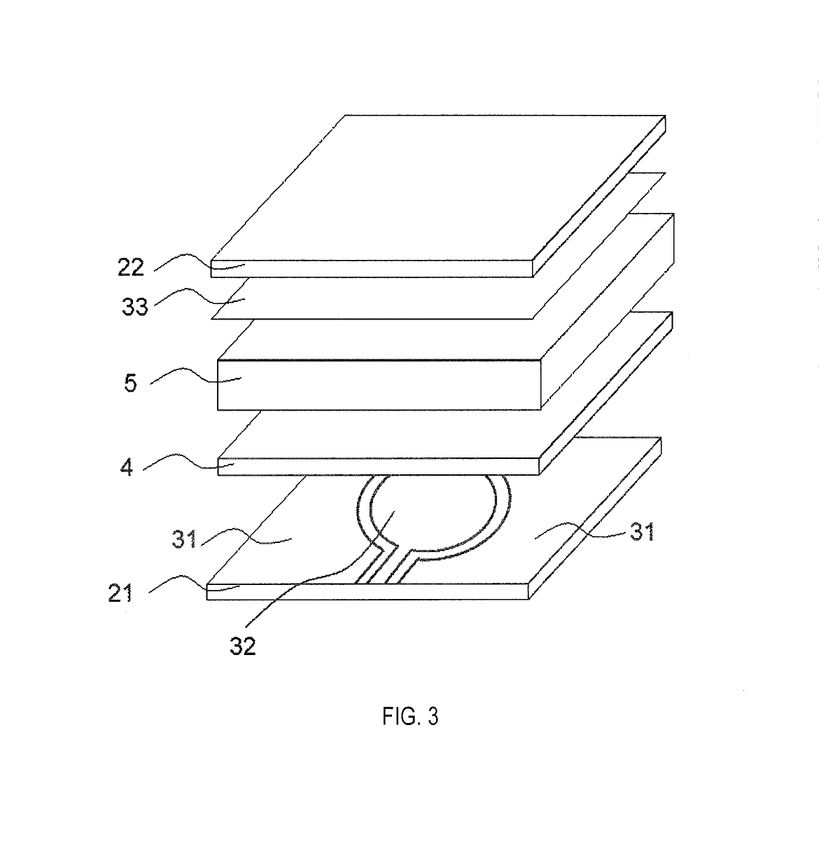

A structure of a liquid crystal lens 1 of Detailed Description 1 is shown in FIGS. 1 and 3. FIG. 1 is a schematic cross-sectional structural view of the liquid crystal lens 1 of Detailed Description 1. FIG. 3 is a perspective view of the liquid crystal lens 1 of Detailed Description 1. The liquid crystal lens 1 of Detailed Description 1 is provided with a first substrate 21, a second substrate 22, and a liquid crystal layer 5. The first substrate is provided with a first electrode 31 having a hole, and a second electrode 32, which is arranged within the hole of the first electrode 31, and spaced from the first electrode 31. The second substrate 22 is provided with a third electrode 33. The liquid crystal layer 5 is formed between an electrode formation surface of the first substrate 21 and an electrode formation surface of the second substrate 22. A functional film 4 is arranged between the first substrate 21 and the liquid crystal layer 5. In at least part of the functional film 4, there is a region that has a continuous composition gradient in a film thickness direction.

In the liquid crystal lens 1 of Detailed Description 1, sheet resistance values of the functional film 4 change along with the film thickness direction. In other words, the sheet resistance value of the functional film 4 on the side of electrodes (31, 32) is different from the sheet resistance value on the liquid crystal layer 5 side. For example, a region in which the functional film 4 contacts the first and second electrodes 31 and 32 is defined as region A, and a region in which the functional film 4 contacts the liquid crystal layer 5 is defined as region B. The sheet resistance value of the region A of the functional film 4 can be made five orders of magnitude or more higher than that of the region B of the functional film 4.

In the liquid crystal lens 1 of Detailed Description 1, a voltage is applied between the first and third electrodes 31 and 33, and between the second and third electrodes 32 and 33. By individually controlling a voltage that is applied between the first and third electrodes 31 and 33, and a voltage that is applied between the second and third electrodes 32 and 33, a potential in a quadratic curve shape is formed over the overall liquid crystal layer 5. An index of refraction of the liquid crystal layer 5 is provided with a distribution according to, the potential in a quadratic curve shape. As a result, a lens effect can be seen in the liquid crystal lens 1 of Detailed Description 1.

In the liquid crystal lens 1 of Detailed Description 1, the first substrate 21 and the second substrate 22 are each constituted by a transparent substrate. The transparent substrate of the Detailed Description 1 refers to a substrate with light transmittance being 50 [%] or higher. An alkali-free glass substrate, a low alkali glass substrate, or the like can be used for a transparent substrate. This is because metal ions are not eluted from these glass substrates. However, the transparent substrates are not limited to the above glass substrates. For example, a transparent resin substrate with a passivation film can be used for a transparent substrate. A thickness of the first and second substrates 21 and 22 can be arbitrarily selected.

As shown in FIG. 3, the liquid crystal lens 1 of Detailed Description 1 is provided with the first electrode 31. The first electrode 31 of Detailed Description 1 is a patterned electrode having a round opening portion in the center. The second electrode 32 of Detailed Description 1 is arranged in the opening portion of the first electrode 31, and spaced from the first electrode 31. The shape of the opening portion of the first electrode 31 does not need to be round. The shape of the opening portion of the first electrode 31 can be elliptical, or polygonal such as quadrangular or hexagonal.

In the liquid crystal lens 1 of Detailed Description 1, materials for the first electrode 31, the second electrode 32, and the third electrode 33 can be arbitrarily selected from among various conductive materials. However, for these electrodes, it is preferable to select a material with high optical transparency, a material with low wavelength dependency of light transmittance, and a material with high chemical stability. For such a material, oxide materials such as indium tin oxide (ITO), titanium oxide (TiOₓ), gallium doped zinc oxide (GZO), aluminum doped zinc oxide (AZO), fluorine doped tin (FTO), and the like; a metal material such as aluminum (Al) and the like are shown as examples. Among these, ITO is preferable for the material of each electrode. This is because among the above materials, ITO has particularly high conductivity and high light transmittance.

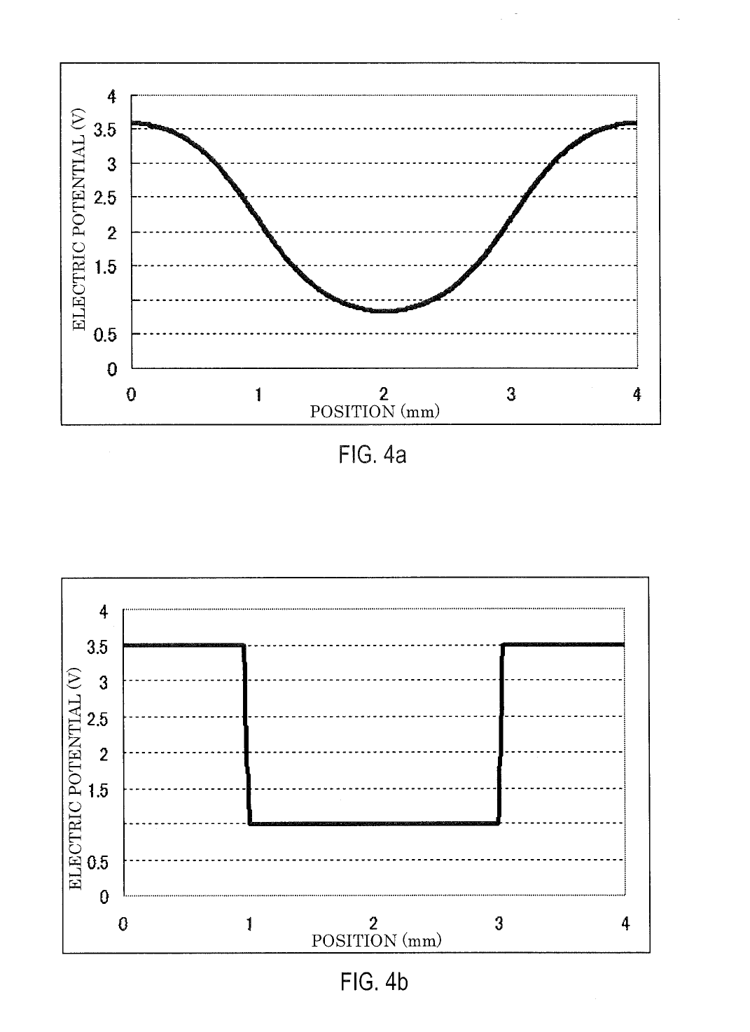

In the liquid crystal lens 1 of Detailed Description 1, in at least part of the functional film 4, a composition gradient portion is provided in a film thickness direction. As a result, the sheet resistance value of a region (region A) of the functional layer 4 contacting the first and second electrodes 31 and 32 is higher than that of a region (region B) contacting the liquid crystal layer 5. FIG. 4a shows a schematic view showing an ideal potential distribution shape of a liquid crystal lens. Additionally, FIG. 4b shows a schematic view showing an undesirable potential distribution shape of a liquid crystal lens. It is desirable to obtain a potential distribution in a quadratic curve shape shown in FIG. 4a such that a lens effect can be seen in the liquid crystal lens 1 of Detailed Description 1. If a magnitude of the sheet resistance value of the region A is made to be five orders of magnitude or more higher than the sheet resistance value of the region B, the potential distribution of the liquid crystal lens 1 becomes close to the potential distribution in a quadratic curve shape shown in FIG. 4a. This potential distribution tends to depend on the frequency of a drive voltage. However, if the difference in the sheet resistance values is set within a range of five to six orders of magnitude, a potential distribution in a quadratic curve shape can be easily obtained within a wide frequency range. If the difference in the sheet resistance values is set at four orders of magnitude or lower, it tends to become a flat-shaped potential distribution, which suggests a bottom of a pot as shown in FIG. 4b. If the liquid crystal lens 1 has this potential distribution, there are cases that a preferable lens effect may not be obtained from the liquid crystal lens 1.

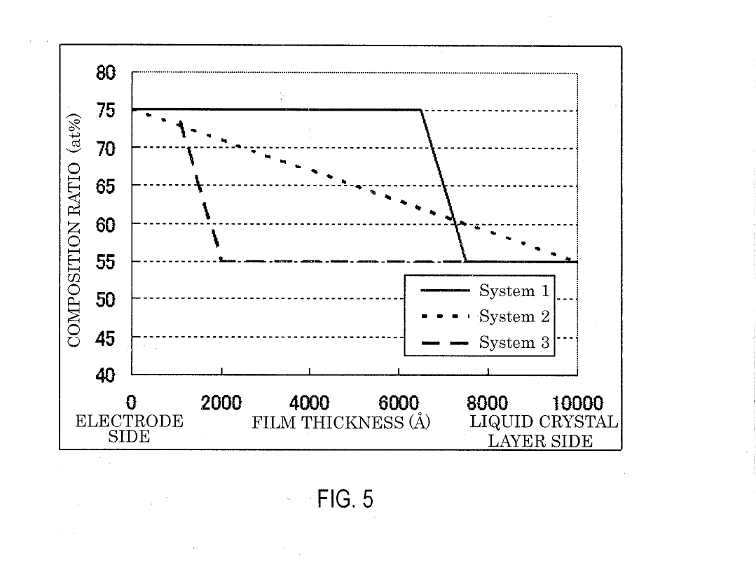

In the liquid crystal lens 1 of Detailed Description 1, a composition gradient region of the functional film 4 can be arbitrarily set. As for the composition gradient region of the functional film 4, as long as the difference in the sheet resistance values between the regions A and B satisfies the earlier-mentioned relationship, it is acceptable. In that case, as shown in system 2 of FIG. 5, a composition gradient region in the film thickness direction can extend over the entire functional film 4. Alternatively, as shown in systems 1 and 3, part of the functional film 4 may have a composition gradient. If the composition gradient region were restricted to part of the functional film 4, it would be easy to control the difference in the sheet resistance values. For example, as shown in system 1 of FIG. 5, if the composition gradient portion is arranged at a region contacting the liquid crystal layer rather than at the electrode side, it seems to be easier to control irregularity of the sheet resistance values.

A material of the functional film 4 of the liquid crystal lens 1 of Detailed Description 1 can be selected from among materials with high transmittance in which conductivity changes according to changes in a composition ratio. For example, a material can be formed as a thin film in which two types of elements or more, which must include any of N, O, F, Mg, Al, Ti, Ni, Zn, Ga, Nb, Ag, In, Sn, Sb, Ta, are combined, and in which the composition ratio of at least two types of the elements is larger than zero in the overall region of the functional film. Additionally, it is also acceptable to form a thin film by including two types of elements or more from among the earlier-mentioned element group and further adding other elements. Furthermore, it is also preferable that the functional film 4 is formed as a thin film by combining the four types of elements Zn, Al, Mg, O, and making the composition ratio of at least three types of atoms larger than zero in the overall region of the functional film. Needless to say, it is not the case that a thin film can be formed by a combination of only the three types N, O, F from among the elements shown as examples.

For a method of forming a composition gradient portion in the functional film 4 of Detailed Description 1, as an example, a method of forming a film can be listed in which a sputtering condition is made to be continuously changed by using a multitarget sputtering device having a plurality of targets, and a composition ratio is made to be continuously changed. Alternatively, a method of thermally diffusing an element by performing appropriate thermal treatment after forming a plurality of layers with different composition ratios; a Sol-Gel method in which a plurality of precursor liquids with different composition ratios are prepared, the precursor liquids are coated on a substrate, and thermal treatment is repeatedly performed; or the like can be used.

The liquid crystal layer 5 of Detailed Description 1 is nematic liquid crystal. For nematic liquid crystal, it is preferable to use (i) liquid crystal that is suitable to a VA (Vertical Alignment) mode, an IPS (In Plane Switching) mode, and an OCB (Optical Compensated Bend) mode, or (ii) liquid crystal that shows a blue phase that is stabilized by forming a cyclic structure of a high polymer inside of the liquid crystal. This is because responsiveness of the liquid crystal layer 5 can be improved. In order to broaden a variable range of an index of refraction of nematic liquid crystal, it is acceptable to reformulate nematic liquid crystal to be a liquid crystal with large anisotropy (An) of the index of refraction by introducing a substituent to the nematic liquid crystal. For such a substituent, there is a substituent that increases polarizability of liquid crystal molecules, such as a cyano group.

### Detailed Description 2

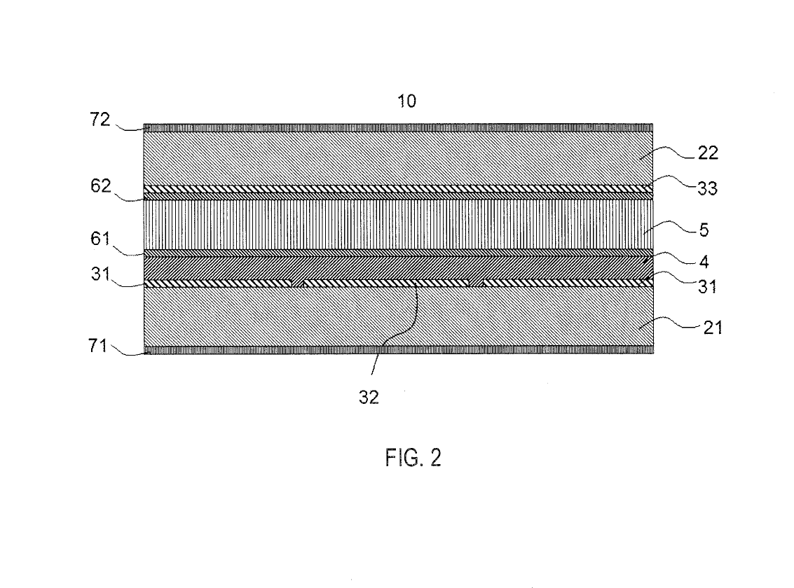

In Detailed Description 2, we show a liquid crystal lens having an orientation film, as an example. FIG. 2 shows a cross-sectional view of a liquid crystal lens of Detailed Description 2. This liquid crystal lens is provided with (i) a first orientation film 61 between the functional film 4 and the liquid crystal layer 5 and (ii) a second orientation film 62 between the liquid crystal layer 5 and the third electrode 33.

A material for the first and second orientation films 61 and 62 used for the liquid crystal lens for Detailed Description 2 is a polyimide resin. Rubbing treatment is performed so as to regularly set the liquid crystal molecules in array within the liquid crystal layer 5. Rubbing treatment can be easily performed by rubbing the first and second orientation films 61 and 62 with a cloth or the like. As a method other than rubbing treatment, a method of forming film orientation by irradiating ultraviolet light to a photosensitive film; a method of using a diagonally vapor-deposited film for an orientation film; and the like can be listed. The first and second orientation films 61 and 62 are arranged such that a rubbing direction of the first orientation film 61 and a rubbing direction of the second orientation film 62 are parallel and opposite to each other.

In the liquid crystal lens of Detailed Description 2, (i) at a surface of the first substrate 21 that is opposite to the surface at which the first and second electrodes 31 and 32 are formed and (ii) at a surface of the second substrate 22 that is opposite to the surface at which the third electrode 33 is formed, a first antireflective film 71 and a second antireflective film 72 can be formed, respectively.

The first antireflective film 71 and the second antireflective film 72 of Detailed Description 2 are films in which SiO₂ and Ta₂O₅ are layered. There is an effect that transmittance of the liquid crystal lens can be improved by reducing a reflected light amount.

### EXAMPLES

We will explain this invention more specifically, using several examples. However, this invention is not limited to the contents of the Examples.

### Example 1

### (Production of Liquid Crystal Lens)

First, a first electrode and a second electrode were formed on a first glass substrate. As the first glass substrate, a glass having a thickness of 300 μm was prepared, having a first antireflective film formed on one surface. On a surface of the first glass substrate opposite to the surface on which the antireflective film was foamed, ITO was formed by a sputtering method. Then, the ITO was divided by etching, and the first and second electrodes were formed. A diameter of the second electrode was 2 mm. The second electrode corresponds to a lens portion.

Next, a functional film was formed on the first glass substrate on which the first and second electrodes were formed. The functional film was a composition gradient film formed of NiO and Ag₂O. For a means of forming the functional film, a method was used which gradually changed an output to be applied to two targets NiO and Ag₂O, using a multitarget sputtering machine. The composition gradient extended over the entire functional film. After that, in order to stabilize sheet resistance values, thermal treatment was performed in atmosphere at 300° C. for 1 hour. In this functional film, film peeling was not generated even after thermal treatment.

The liquid crystal lens that was ultimately obtained via later-mentioned steps was analyzed, and the sheet resistance values of the functional film were evaluated by a four-point probe measurement device. A sheet resistance value on an uppermost surface side (liquid crystal layer side) was approximately 1.0×10⁷[Ω/□]. The measured functional film was etched to 10% of the film thickness of the functional film, and the sheet resistance value on the electrode side was measured. The sheet resistance value on the electrode side was approximately 1.0×10¹⁴[Ω/□]. As a result, it was confirmed that the sheet resistance value of the functional film on the electrode side was approximately seven orders of magnitude larger than the sheet resistance value on the liquid crystal side.

Next, a first orientation film formed of polyimide was formed on the surface of the functional film, and rubbing treatment was performed thereon.

Next, a second glass substrate was prepared. A third electrode was formed by forming ITO on the second glass substrate by a sputtering method. Then, a second orientation film formed of polyimide was formed on the surface of the second glass substrate on which the third electrode was formed. In the same manner as for first orientation film, rubbing treatment was performed for the second orientation film.

The first glass substrate on which the first orientation film was formed and the second glass substrate on which the second orientation film was formed were fixed facing each other. The two glass substrates were arranged and fixed such that the surface of the first orientation film and the surface of the second orientation film faced each other and rubbing directions of the two orientation films were parallel and opposite to each other. A liquid crystal layer was formed by vacuum-sealing (i) a liquid crystal material and (ii) spherical spacers having a diameter of 30 μm between the first and second orientation films. A thickness of the liquid crystal layer was 30 μm. A liquid crystal lens of Example 1 was produced, using the above process.

The following evaluation was performed for the liquid crystal lens and the functional film of Example 1.

### (Evaluation of Potential Distribution)

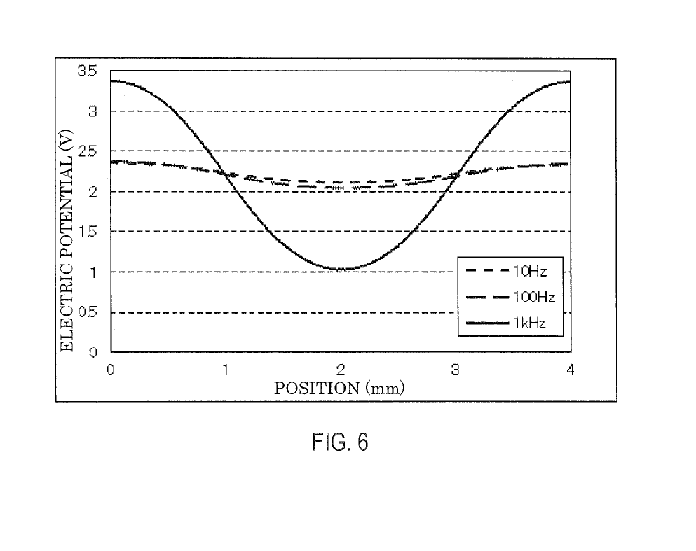

A voltage was applied to the liquid crystal lens of Example 1, A voltage of 3.5 [Vrms] was applied between the first and third electrodes, and a voltage of 1.0 [Vrms] was applied between the second and third electrodes, at 10 [Hz], 100 [Hz], and 1 [kHz]. FIG. 6 shows potential distributions that were generated in liquid crystal at that time. The potential distribution was a quadratic curve shape at a drive frequency of 1 [kHz], and a large potential difference was obtained. As a result, this means that a lens effect can be obtained from the liquid crystal lens of Example 1.

### (Evaluation of Adhesiveness)

Adhesiveness of the functional film was evaluated by a tape pulling and stripping test. The sample for the tape pulling and stripping test is a dummy sample for adhesiveness evaluation of Example 1. The dummy sample is a sample that was collected at the point during the process of Example 1 at which the functional film was formed. A tape pulling and stripping test was used in which squares were formed by vertically and horizontally cutting the functional film to the ITO at an interval width of 1 mm in vertical and horizontal directions. Adhesiveness was quantified by measuring the number of small pieces that were adhered to the tape and peeled from the tape within 100 squares of the functional film. Table 1 shows a test result of the adhesiveness evaluation of Example 1. The functional film of Example 1 had good adhesiveness. Even after performing thermal treatment at 300° C., the functional film of Example 1 showed strong adhesiveness.

### (Evaluation of Optical Characteristic)

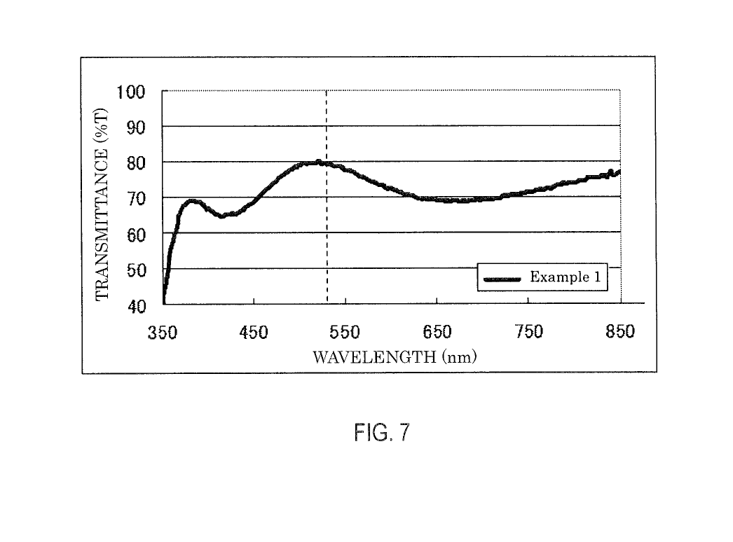

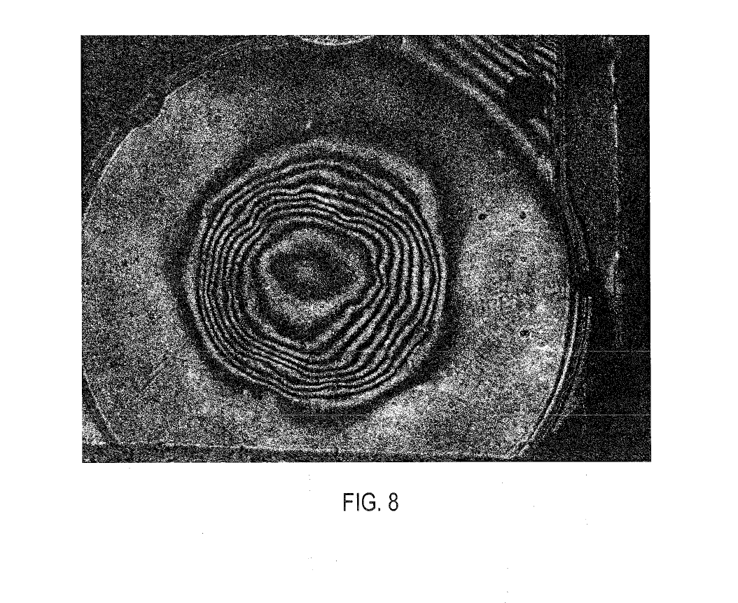

Transmittance of the functional film within a wavelength of 250 [nm]-1000 [nm] was measured by using a spectrum ellipsometer. For measuring, initial transmittance of a sample in which an ITO film was formed on the first glass substrate was measured, and then a functional film was formed on the sample under the same conditions as in Example 1. After the functional film was formed, transmittance was measured, initial transmittance was subtracted from that data, and the transmittance of the functional film alone was calculated. FIG. 7 shows an evaluation result of transmittance of Example 1. Table 1 shows transmittance at a wavelength of 532 [nm]. It was confirmed that 65 [%] or higher of transmittance is shown in a visible light region and that a high optical characteristic is provided.

### Example 2

In Example 2, a functional film of a liquid crystal lens was made to be a composition gradient film formed of NiO, Ag₂O, and MgO. A composition gradient ratio of the functional film was adjusted at the time the functional film was formed so that the sheet resistance value of the functional film was approximately 1.0×10⁷[Ω/□] on the liquid crystal layer side, and approximately 1.0×10¹⁴[Ω/□] on the electrode side. Other compositions, conditions, and the like were the same as in Example 1, and the same evaluations as in Example 1 were performed. Table 1 shows a result of evaluating the liquid crystal lens and the functional film of Example 2.

### Example 3

In Example 3, a functional film of a liquid crystal lens was made to be a composition gradient film formed of TiO₂ and NbO. A composition gradient ratio of the functional film was adjusted at the time the functional film was formed so that the sheet resistance value of the functional film was approximately 1.0×10⁷[Ω/□] on the liquid crystal layer side, and approximately 1.0×10¹⁴[Ω/□] on the electrode side. Other compositions, conditions, and the like were the same as in Example 1, and the same evaluations as in Example 1 were performed. Table 1 shows a result of evaluating the liquid crystal lens and the functional film of Example 3.

### Example 4

In Example 4, a functional film of a liquid crystal lens was made to be a composition gradient film formed of Ta₂O₅ and N₂. A composition gradient ratio of the functional film was adjusted at the time the functional film was formed so that the sheet resistance value of the functional film was approximately 1.0×10⁷[Ω/□] on the liquid crystal layer side, and approximately 1.0×10¹²[Ω/□] on the electrode side. Other compositions, conditions, and the like were the same as in Example 1, and the same evaluations as in Example 1 were performed. Table 1 shows a result of evaluating the liquid crystal lens and the functional film of Example 4.

### Example 5

In Example 5, a functional film of a liquid crystal lens was made to be a composition gradient film formed of F and SnO₂. A composition gradient ratio of the functional film was adjusted at the time the functional film was formed so that the sheet resistance value of the functional film was approximately 1.0×10⁷[Ω/□] on the liquid crystal layer side, and approximately 1.0×10¹⁵[Ω/□] on the electrode side. Other compositions, conditions, and the like were the same as in Example 1, and the same evaluations as in Example 1 were performed. Table 1 shows a result of evaluating the liquid crystal lens and the functional film of Example 5.

### Example 6

In Example 6, a functional film of a liquid crystal lens was made to be a composition gradient film formed of Sb₂O₃ and SnO₂. A composition gradient ratio of the functional film was adjusted at the time the functional film was formed so that the sheet resistance value of the functional film was approximately 1.0×10⁷[Ω/□] on the liquid crystal layer side, and approximately 1.0×10¹⁴[Ω/□] on the electrode side. Other compositions, conditions, and the like were the same as in Example 1, and the same evaluations as in Example 1 were performed. Table 1 shows a result of evaluating the liquid crystal lens and the functional film of Example 6.

### Example 7

In Example 7, a functional film of a liquid crystal lens was made to be a composition gradient film formed of Ga₂O₃ and ZnO. A composition gradient ratio of the functional film was adjusted at the time the functional film was formed so that the sheet resistance value of the functional film was approximately 1.0×10⁷[Ω/□] on the liquid crystal layer side, and approximately 1.0×10¹⁴[Ω/□] on the electrode side. Other compositions, conditions, and the like were the same as in Example 1, and the same evaluations as in Example 1 were performed. Table 1 shows a result of evaluating the liquid crystal lens and the functional film of Example 7.

### Example 8

In Example 8, a functional film of a liquid crystal lens was made to be a composition gradient film formed of In₂O₃ and SnO₂. A composition gradient ratio of the functional film was adjusted at the time the functional film was formed so that the sheet resistance value of the functional film was approximately 1.0×10⁷[Ω/□] on the liquid crystal layer side, and approximately 1.0×10¹⁵[Ω/□] on the electrode side. Other compositions, conditions, and the like were the same as in Example 1, and the same evaluations as in Example 1 were performed. Table 1 shows a result of evaluating the liquid crystal lens and the functional film of Example 8.

### Example 9

In Example 9, a functional film of a liquid crystal lens was made to be a composition gradient film formed of ZnO, Al₂O₃, and MgO. A composition gradient ratio of the functional film was adjusted at the time the functional film was formed so that the sheet resistance value of the functional film was approximately 1.0×10⁷[Ω/□] on the liquid crystal layer side, and approximately 1.0×10¹⁵[Ω/□] on the electrode side. Other compositions, conditions, and the like were the same as in Example 1, and the same evaluations as in Example 1 were performed. Table 1 shows a result of evaluating the liquid crystal lens and the functional film of Example 9.

The evaluation results of Examples 2-9 (see Table 1) clarified that a liquid crystal lens in which any of the materials shown by us as an example is used for a functional film is provided with preferable characteristics. In examples of Example 10 and after, by using a composition of ZnO, Al₂O₃, and MgO that is the functional film of Example 9 as an example, a composition gradient structure of the functional film was considered.

### Example 10

In Example 10, a functional film of a liquid crystal lens was made to be a composition gradient film formed of ZnO, Al₂O₃, and MgO. The functional film of Example 10 was formed such that a composition gradient region exists in a region close to the liquid crystal layer side. A composition gradient ratio of the functional film was adjusted at the time the functional film was formed so that the sheet resistance value of the functional film was approximately 1.0×10⁷[Ω/□] on the liquid crystal layer side, and approximately 1.0×10¹⁴[Ω/□] on the electrode side. Other compositions, conditions, and the like were the same as in Example 1. Table 1 shows a result of evaluating the liquid crystal lens and the functional film of Example 10.

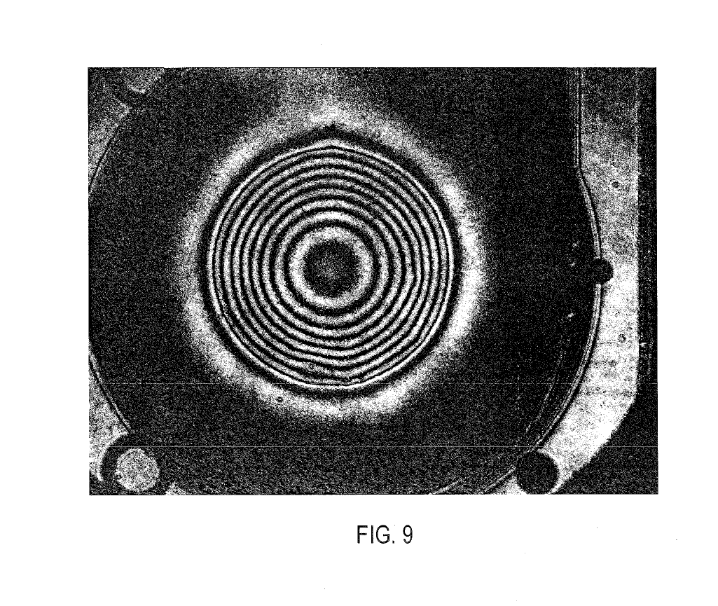

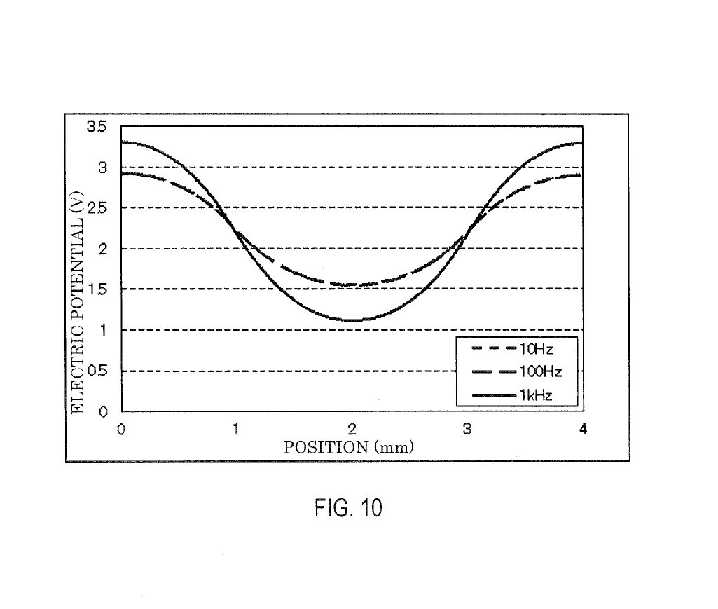

An image of an interference fringe was evaluated for the liquid crystal lens of Example 10. This is to evaluate the effect of the position occupied by a composition gradient portion of the functional film on the function of the liquid crystal lens. FIG. 10 is a photograph of an interference fringe when the liquid crystal lens is driven in a normal manner. FIG. 9 is a photograph in which an interference fringe is changed due to an insulation failure between the first and second electrodes. When the functional films of Examples 1-9 were used, hardly any samples were observed that showed an interference fringe as shown in FIG. 9. We thought that this is because according to the methods of Examples 1-9, the composition gradient extended over the entire functional film. In a region of the functional film close to an electrode, there is a possibility that the composition of the functional film may change, and the sheet resistance value may fluctuate. In the liquid crystal lens of Example 10, a composition gradient portion is not in a region close to an electrode. Thus, there is a possibility that the composition change in the functional film in the vicinity of the electrode(s) may be able to be controlled. As shown in Example 10, a structure that is formed with the composition gradient of the functional film separated from the electrode(s) may be able to form a more ideal potential distribution.

### Example 11

In Example 11, a functional film of a liquid crystal lens was made to be a composition gradient film formed of ZnO, Al₂O₃, and MgO. The liquid crystal lens was produced by forming a functional film such that a composition gradient region exists, weighted toward a region close to the liquid crystal layer side. A composition gradient ratio of the functional film was adjusted at the time the functional film was formed so that the sheet resistance value of the functional film was approximately 1.0×10⁷[Ω/□] on the liquid crystal layer side, and approximately 1.0×10¹³[Ω/□] on the electrode side. For this functional film, the above-mentioned difference of the sheet resistance values is approximately six orders of magnitude. Other compositions and manufacturing conditions were the same as in Example 1.

### Example 12

In Example 12, a functional film of a liquid crystal lens was made to be a composition gradient film formed of ZnO, Al₂O₃, and MgO, and the liquid crystal lens was produced. A composition gradient ratio of the functional film was adjusted at the time the functional film was formed so that the sheet resistance value of the functional film was approximately 1.0×10⁷[Ω/□] on the liquid crystal layer side, and approximately 1.0×10¹²[Ω/□] on the electrode side. For this functional film, the above-mentioned difference of the sheet resistance values is approximately five orders of magnitude. Other compositions and manufacturing conditions were the same as in Example 1.

A potential distribution was evaluated for the liquid crystal lens of Examples 11 and 12. This is to clarify an effect that the magnitude of the difference between the sheet resistance value of the functional film on the liquid crystal layer side and the sheet resistance values on the electrode layer side has on the function of the liquid crystal lens. FIG. 11 shows an evaluation result of the potential distribution of the liquid crystal lens of Example 11. Table 1 shows other evaluation results. For the liquid crystal lens of Example 1 as shown above, the potential difference was small at frequencies other than a drive frequency of 1 kHz, and lens power was small (see FIG. 6). As shown in FIG. 11, for the liquid crystal lens of Example 11, a magnitude of a potential difference at 1 kHz was smaller than that of Example 1, but this was a potential difference that was sufficient for the liquid crystal lens to obtain a lens effect. Furthermore, for the liquid crystal lens of Example 11, a potential difference was obtained that was sufficient to obtain a lens effect at three frequencies of 1 kHz, 10 Hz, and 1 Hz. For the liquid crystal lens of Example 11, a preferable potential distribution in a quadratic curve shape was observed. The liquid crystal lens of Example 12 also had the same result as the liquid crystal lens of Example 11. The evaluation results of the liquid crystal lenses of Examples 11 and 12 mean that a liquid crystal lens with small frequency dependency can be obtained if the sheet resistance value of the functional film of the liquid crystal lens on the liquid crystal layer side is made to be five to six orders of magnitude different from the sheet resistance value on the electrode side. Additionally, the evaluation results of the liquid crystal lenses of Examples 11 and 12 show that if a composition gradient portion of the functional film exists that is weighted toward a film thickness direction, the effect on the characteristics of the liquid crystal lens is small, compared to a case in which a composition gradient portion exists that is weighted toward the vicinity of the electrode(s) (see the evaluation results of Examples 1-9).

### Example 13

In Example 13, a functional film was made to be a composition gradient film formed of NiO and Ag₂O. A composition gradient ratio of the functional film was adjusted at the time the functional film was formed so that the sheet resistance value of the functional film was approximately 1.0×10⁷[Ω/□] on the liquid crystal layer side, and approximately 1.0×10¹⁰[Ω/□] on the electrode side. Other compositions and experiment conditions were the same as in Example 1. Table 1 shows a result of evaluating the liquid crystal lens and the functional film of Example 13.

### Example 14

In Example 14, a functional film was made to be a composition gradient film formed of NiO and Ag₂O. A composition gradient ratio of the functional film was adjusted at the time the functional film was formed so that the sheet resistance value of the functional film was approximately 1.0×10⁷[Ω/□] on the liquid crystal layer side, and approximately 1.0×10¹¹[Ω/□] on the electrode side. Other compositions and experiment conditions were the same as in Example 1. Table 1 shows a result of evaluating the liquid crystal lens and the functional film of Example 14.

Potential distributions were evaluated for the liquid crystal lenses of Examples 13 and 14. With respect to the functional films of the liquid crystal lenses of Examples 13 and 14, the sheet resistance values on the liquid crystal layer side were smaller than the sheet resistance values on electrode side by five orders of magnitude or less. Even in this structure, the liquid crystal lens shows somewhat of a lens effect. However, the potential distribution of the liquid crystal lenses of Examples 13 and 14 becomes a potential distribution that has the shape of a bottom of a pot as shown in FIG. 4b. Thus, there may be cases that it is difficult to obtain a high lens effect. In order for the liquid crystal lens to obtain a potential distribution in a quadratic curve shape, it is necessary to increase the difference between the sheet resistance value on the liquid crystal layer side and the sheet resistance value on the electrode side to a certain degree. An experimental result shows that it is preferable that the difference should be five orders of magnitude or more.

### Comparative Example

In a Comparative Example, instead of the functional film of this invention, a liquid crystal lens using a conventional double-layer structure was produced. A double-layer structure is a layered structure of an insulation film and a high resistance layer. In the liquid crystal lens of the Comparative Example, SiO₂ was used as the insulation film, and a film in which Ag₂O was added to NiO was used as the high resistance layer. Other compositions and experiment conditions were the same as in Example 1. Table 1 shows a result of evaluating the liquid crystal lens and the functional film of the Comparative Example.

The liquid crystal lens of the Comparative Example is a conventional double-layer structure using an insulation film and a high resistance layer. With respect to this liquid crystal lens, the difference in the sheet resistance values is seven orders of magnitude, which is large. It is thought that a preferable potential distribution can be obtained. However, as is clear from the result of film peeling test, adhesiveness cannot be sufficiently obtained. Additionally, in the liquid crystal lens of the Comparative Example, there were cases that film peeling was generated in a thermal treatment step. With respect to the liquid crystal lens of the Comparative Example, transmittance of the double-layer structure was inferior to the functional film of Examples 1-14. This is because a rapid change occurred in the index of refraction at the interface of the double-layer structure.

The results of the above Examples show that the liquid crystal lenses of this invention (1) have no film peeling, (2) have an excellent optical characteristic, and (3) can form an ideal potential distribution.

TABLE 1

| | | | Composition | | The shape | Adher- | | | Rate of |
|---|---|---|---|---|---|---|---|---|---|
| Exam- | | | gradient | Ratio of | of the | ence | Trans- | | insulation |
| ple | Structure | Materials | region in the | the sheet | electric | Test | mittance | Frequency- | failure |
| No. | of the film | of the film | functional film | resistance | potential | (n/100) | (532 nm, % T) | dependence | (%) |
| 1 | Functional film | NiO, Ag₂O | The whole | seven-digit | ∘ | 3 | 79 | large | 4 |
| 2 | Functional film | NiO, Ag₂O, MgO | The whole | eight-digit | ∘ | 3 | 80 | large | 4 |
| 3 | Functional film | TiO₂, NbO | The whole | seven-digit | ∘ | 2 | 80 | large | 3 |
| 4 | Functional film | Ta₂O₅, N₂ | The whole | seven-digit | ∘ | 2 | 81 | large | 3 |
| 5 | Functional film | F, SnO₂ | The whole | eight-digit | ∘ | 1 | 81 | large | 3 |
| 6 | Functional film | Sb₂O₃, SnO₂ | The whole | seven-digit | ∘ | 1 | 82 | large | 1 |
| 7 | Functional film | Ga₂O₃, ZnO | The whole | seven-digit | ∘ | 1 | 82 | large | 1 |
| 8 | Functional film | In₂O₃, SnO₂ | The whole | eight-digit | ∘ | 1 | 84 | large | 1 |
| 9 | Functional film | ZnO, Al₂O₃, MgO | The whole | eight-digit | ∘ | 1 | 88 | large | 1 |
| 10 | Functional film | ZnO, Al₂O₃, MgO | A part | seven-digit | ∘ | 0 | 90 | large | 0 |
| | | | (near the LC | | | | | | |
| | | | layer side) | | | | | | |
| 11 | Functional film | ZnO, Al₂O₃, MgO | A part | six-digit | ∘ | 0 | 90 | small | 0 |
| | | | (near the LC | | | | | | |
| | | | layer side) | | | | | | |
| 12 | Functional film | ZnO, Al₂O₃, MgO | A part | five-digit | ∘ | 0 | 91 | small | 0 |
| | | | (near the LC | | | | | | |
| | | | layer side) | | | | | | |
| 13 | Functional film | NiO, Ag₂O | The whole | three-digit | x | 4 | 78 | — | — |
| 14 | Functional film | NiO, Ag₂O | The whole | four-digit | x | 3 | 77 | — | — |
| Compar- | Insulator and | Insulator: SiO₂ | — | seven-digit | ∘ | 13 | 74 | large | 0 |
| ative | high regitively | High regitively film: | | | | | | | |
| Exam- | film | NiO, Ag₂O | | | | | | | |
| ple | | | | | | | | | |

What we claim is:

1. A liquid crystal lens, comprising:
a first substrate having a first electrode and a second electrode on one surface;
a second substrate having a third electrode on one surface;
a liquid crystal layer; and
a functional film, wherein:
the liquid crystal layer is arranged between the surface of the first substrate on which the first and second electrodes are formed and the surface of the second substrate on which the third electrode is formed;
the functional film is arranged between the second substrate and the liquid crystal layer; and
at least part of the functional film has a composition gradient portion in which a composition has a continuous gradient in a film thickness direction.

2. The liquid crystal lens as set forth in claim 1, wherein:
a sheet resistance value of the functional film of a region (region A) in which the functional film contacts the first and second electrodes is larger than a sheet resistance value of the functional film of a region (region B) in which the functional film contacts the liquid crystal layer by five orders of magnitude or more.

3. The liquid crystal lens as set forth in claim 1, wherein:
the functional film is formed as a thin film in which two types of elements or more from among N, O, F, Mg, Al, Ti, Ni, Zn, Ga, Nb, Ag, In, Sn, Sb, Ta must be included, and a composition ratio of at least two types of the elements is larger than zero in the overall region of the functional film.

4. The liquid crystal lens as set forth in claim 1, wherein:
the functional film is formed as a thin film by combining four types of elements Zn, Al, Mg, O, and the composition ratio of at least three types of elements is larger than zero in the overall region of the functional film.

5. The liquid crystal lens as set forth in claim 1, wherein:
the functional film has the composition gradient portion more on the region B side than on the region A side.

6. The liquid crystal lens as set forth in claim 1, wherein:
the sheet resistance value of the functional film of the region A is larger than the sheet resistance value of the functional film of the region B by five to six orders of magnitude.
